(19) United States
(12) Patent Application Publication
(10) Pub. No.: US 2020/0369265 A1
(43) Pub. Date: Nov. 26, 2020

(54) Parked Vehicle Active Collision Avoidance and Multimedia System

(71) Applicant: Mani Fasihozaman, Huntington Beach, CA (US)

(72) Inventor: Mani Fasihozaman, Huntington Beach, CA (US)

(21) Appl. No.: 16/883,728

(22) Filed: May 26, 2020

Related U.S. Application Data
(60) Provisional application No. 62/851,974, filed on May 23, 2019.

(51) Int. Cl. B60W 30/09; B60W 30/095; B60Q 9/00; B60W 50/14

(52) U.S. Cl. CPC B60W 30/09; B60W 30/0956; B60Q 9/008; B60W 2556/45; B60W 2420/42; B60W 2050/146; B60W 50/14

(57) ABSTRACT

A parked vehicle active collision avoidance and multimedia system is shown and described. The parked vehicle active collision avoidance and multimedia system includes at least one proximity sensor secured to an exterior of a vehicle. The proximity sensor is connected to a controller. The controller is connected to at least one light system. The light system includes a multitude of lights. The controller will illuminate at least one light of the light system when an object passes into a distance threshold. As the object comes closer and enters decreasing distance thresholds, additional lights will be illuminated by the controller.

### CROSS REFERENCE TO RELATED APPLICATIONS

This application claims the benefit of U.S. Provisional Application No. 62/851,974 filed on May 23, 2019. The above identified patent application is herein incorporated by reference in its entirety to provide continuity of disclosure.

### BACKGROUND OF THE INVENTION

The present invention relates to a collision warning system. More particularly, the present invention provides a system that will alert a driver that they are about to hit a parked vehicle.

Many individuals are fond of their vehicles. These individuals may take great care of such vehicles. However, accidents happen. Additionally, others may not exercise the same degree of care as the vehicle owner. Drivers tend to accidentally bump into park vehicles by mistake.

In city situations, these accidental bumps are all the more likely to occur. When parallel parking an individual may not have a backup camera to determine exactly where the vehicle behind them is located. This could cause the driver to tap the parked vehicle. In other circumstances drivers may accidently contact a parked vehicle in a narrow street with a vehicle mirror or other protruding item. All of these bumps may leave a scratch on the parked vehicle.

Further still, individuals that are walking near parked vehicles may cause scratches to occur. When walking near a car an individual may bump into the car. A zipper or snap form the pedestrians clothing may cause a scratch. Further, if a bump occurs with force a dent may be left in the parked vehicle. Current alarm systems will not activate until after the damage has already been done.

Consequently, there is a need for an improvement in the art of collision avoidance. The present invention substantially diverges in design elements from the known art while at the same time solves a problem many people face when driving a vehicle near parked vehicles. In this regard the present invention substantially fulfills these needs.

### SUMMARY OF THE INVENTION

The present invention provides a parked vehicle collision avoidance warning system wherein the same can be utilized for providing convenience for the user when using a parked vehicle active collision avoidance and multimedia system. The parked vehicle active collision avoidance and multimedia system is comprised of at least one proximity sensor secured to the exterior of a vehicle. The at least one proximity sensor is electrically connected to a controller. The controller is electrically connected to at least one light system. The light system includes a multitude of lights. The controller will illuminate at least one light of the light system when an object is detected within a threshold distance.

Another object of the parked vehicle active collision avoidance and multimedia system is to provide a controller that will illuminate additional lights of the light system as decreasing distance thresholds are passed.

Another object of the parked vehicle active collision avoidance and multimedia system is to provide a power source electrically connected to the at least one proximity sensor, the controller, and the at least one light.

Another object of the parked vehicle active collision avoidance and multimedia system is to provide a power source that is separate from the vehicle power source.

Another object of parked vehicle active collision avoidance and multimedia system is to provide a light system that is comprised of LED lights.

Another object of the parked vehicle active collision avoidance and multimedia system is to provide at least one speaker electrically connected to the controller.

Another object of the parked vehicle active collision avoidance and multimedia system is to provide a controller that will have the speaker to play a sound when an object is detected within the threshold distance.

Another object of the parked vehicle active collision avoidance and multimedia system is to provide at least one camera secured to the exterior of the vehicle.

Another object of the parked vehicle active collision avoidance and multimedia system is to provide a controller that will tell the speaker to play a media message.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a wiring diagram of an embodiment of a parked vehicle active collision avoidance and multimedia system.

FIG. 2 shows an alternative wiring diagram of an embodiment of the parked vehicle active collision avoidance and multimedia system.

FIG. 3 shows a perspective view of an embodiment of the parked vehicle active collision avoidance and multimedia system installed on a vehicle.

FIG. 4 shows an in-use view of an embodiment for the parked vehicle active collision avoidance and multimedia system.

FIG. 5 shows a wiring diagram of an embodiment of the parked vehicle active collision avoidance and multimedia system.

### LIST OF REFERENCE NUMERALS

With regard to the reference numerals used, the following numbering is used throughout the drawings.
101 Power source
102 Controller
103 At least one Sensor
104 Speaker
105 At least one Light
201 Light System
202 Light
301 Parked Vehicle
301a Parked vehicle side mirror
301b Parked vehicle headlight
302 moving vehicle
501 Camera
502 Wireless transceiver
503 Display screen

### DETAILED DESCRIPTION OF THE INVENTION

Reference is made herein to the attached drawings. Like reference numerals are used throughout the drawings to depict like or similar elements of the parked vehicle active collision avoidance and multimedia system. For the purposes of presenting a brief and clear description of the present invention, a preferred embodiment will be discussed as used for the parked vehicle active collision avoidance and multimedia system. The figures are intended for representative purposes only and should not be considered to be limiting in any respect.

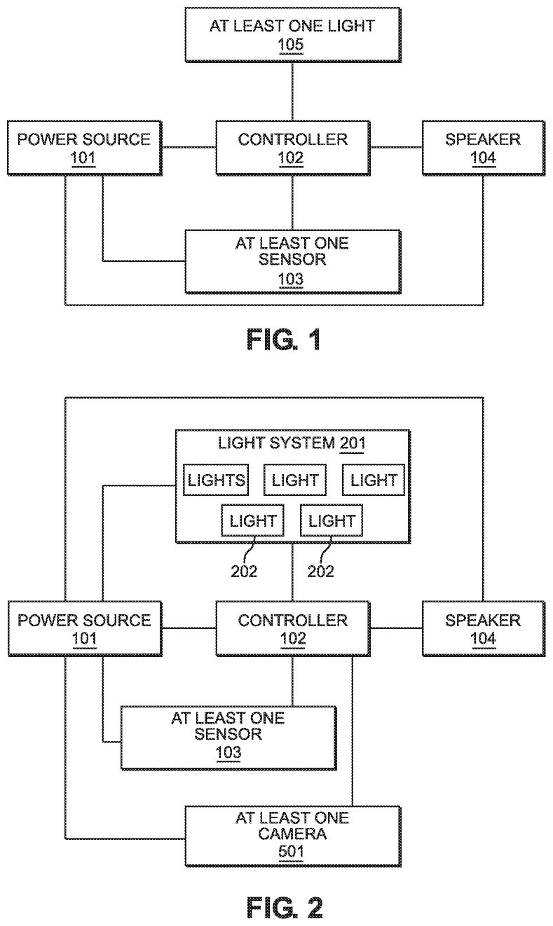

Referring now to FIG. 1, there is shown a wiring diagram of an embodiment of the parked vehicle active collision avoidance and multimedia system. The parked vehicle collision avoidance warning system includes a power source 101. In one embodiment, the power source 101 is the car battery. This will allow the system to be simply integrated into an existing vehicle. In another embodiment, the power source 101 is a power source that is separate from the car battery. Using a separate power source 101 will ensure that the car battery is not depleted, and the car will not be rendered in operable. In one embodiment the power source 101 is at least one solar panel secured to the vehicle. In another embodiment the power source 101 is an additional battery. In one embodiment the additional battery is coupled to the existing vehicle battery to increase power storage capacity.

The power source 101 is electrically coupled to a controller 102. The controller 102 will operate the system. The controller 102 will include a computer readable storage media and a CPU. This will allow the controller 102 to properly store and execute necessary functions. In one embodiment, the controller 102 is integrated into an existing CPU. In another embodiment, the controller 102 is an independent controller 102.

The power source 101 and the controller 102 are further electrically connected to at least one sensor 103. In one embodiment, the at least one sensor 103 is a proximity sensor. In another embodiment, the at least one sensor 103 is a motion sensor. The at least one sensor 103 is mounted to the vehicle such that the at least one sensor 103 monitors the exterior of the vehicle.

The power source 101 and the controller 102 are further electrically connected to a speaker 104. The speaker 104 is configured to play sounds at different volumes. The volumes will be determined by the controller 102. In some embodiments, there may be additional speakers 104.

In one embodiment, the power source 101 and the controller 102 are further electrically connected to at least one light 105. The at least one light 105 is configured to be activated and deactivated by the controller 102. In one embodiment, the light 105 is an LED light. This will allow for maximum brightness from a relatively small light source. In one embodiment, the at least one light 105 is a strobe light.

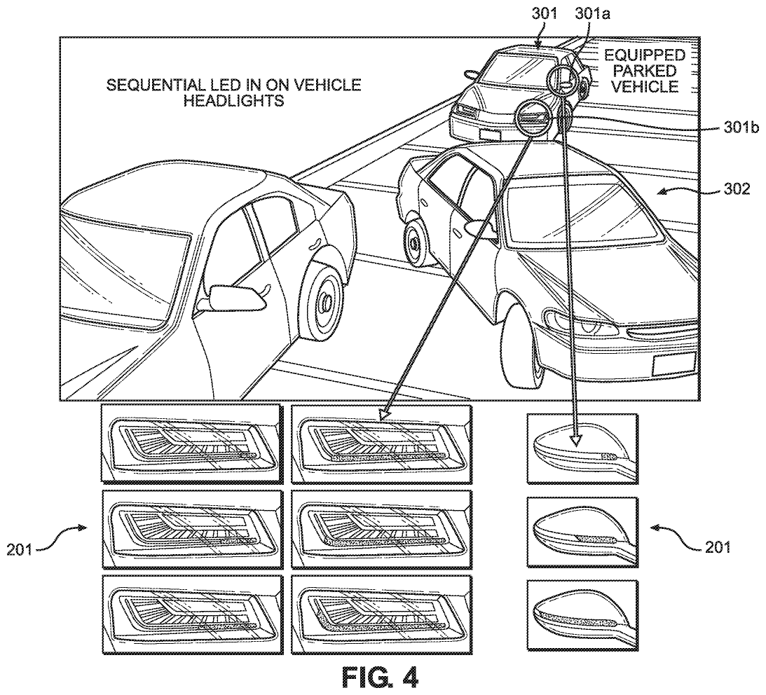

Referring now to FIG. 2, there is shown an alternative wiring diagram of an embodiment of the parked vehicle active collision avoidance and multimedia system. In another embodiment of the system, there is a power source 101, a controller 102, at least one sensor 103, and a speaker 104. These components are connected as described in FIG. 1. This embodiment includes a light system 201 instead of at least one light. The light system 201 is comprised of a plurality of individual lights 202. In one embodiment, the light system 201 is encased in a single housing. In another embodiment the light system 201 is spread around a vehicle. The light system 201 will allow the lights 202 to illuminate in specific patterns to indicate various messages as they are illuminated by the controller 102. This will be described in more detail in the description of FIG. 4.

In this embodiment, there is at least one camera 501 electrically coupled to the power source 101 and the controller 102. At least one camera 501 may also be incorporated into the embodiments of the system as described in FIG. 1. In one embodiment, the at least one camera 501 is configured to record images from the vehicle surroundings. In another embodiment, the at least one camera 501 is configured to record video of the vehicle surroundings. In one embodiment, the controller 102 will tell the at least one camera 501 to activate similarly to the activations of the lights 202 as described in FIG. 4.

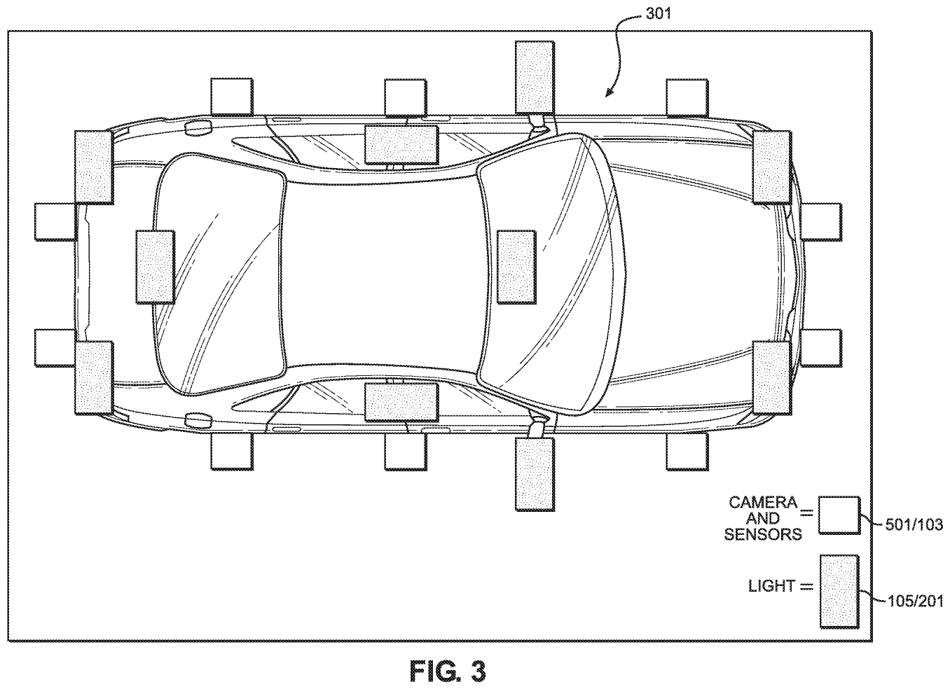

Referring now to FIG. 3, there is shown a perspective view of an embodiment of the parked vehicle active collision avoidance and multimedia system installed on a vehicle. The shown embodiment has a vehicle 301 having a plurality of sensors 103 and cameras 501 secured to the vehicle 301. In the shown embodiment, the sensors 103 and cameras 501 are placed such that the entire perimeter of the vehicle 301 is covered by the sensors 103 and cameras 501. In the shown embodiment the sensors 103 and cameras 501 are one unit. This will enable a simplified installation and space saving quality when the system is installed. In one embodiment, there are only sensors 103 and cameras 501 on the front and rear of the vehicle 301. This will warn of impacts primarily during parallel parking. In different embodiment, the sensors 103 and cameras 501 may be placed in different locations and still cover the entire perimeter of the vehicle 301.

The shown embodiment has a vehicle 301 having a plurality of cameras 501 secured to the vehicle 301. In the shown embodiment, the cameras 501 are placed such that the entire perimeter of the vehicle 301 is covered by the cameras 501. In one embodiment, there are only cameras 501 on the front and rear of the vehicle 301. In another embodiment, the cameras 501 may be placed in different locations than indicated in the shown embodiment while still covering the entire perimeter of the vehicle 301.

There is also a plurality of lights placed around the vehicle. The plurality of lights may be individual lights 105 or light systems 201. In one embodiment there are a combination of different lights 105/201 placed around the vehicle. In different embodiments the individual lights 105 or the light systems 201 may be of all different types. In one embodiment a light may illuminate in a blinking fashion. In another embodiment the lights may show a digital readout of numbers to indicate distance. In yet a further embodiment the lights are strobe lights. In one embodiment the lights will strobe with increased frequency the closer a vehicle enters into the proximity of the vehicle. In a further embodiment the lights change color as a vehicle enter into the proximity of the vehicle. For example, when a car is within 3 feet the lights may turn yellow, and when the car enters one foot the lights may turn red. In another embodiment the lights are continuous lights that encompass an entire perimeter of the vehicle 301.

Referring now to FIG. 4, there is shown an in-use view of an embodiment for the parked vehicle active collision avoidance and multimedia system. The shown embodiment shows the system secured to a vehicle 301 using the light system 201. In the shown embodiment, there is a light system 201 secured to a side mirror 301a of the vehicle 301. There is a second light system 201 secured to a headlight section 301b of the vehicle 301. In different embodiments, additional light systems 201 are secured to the vehicle 301. In other embodiments, the light systems 201 are secured to the vehicle 301 in different locations.

In one embodiment of use, the parked vehicle collision avoidance warning system will warn individuals in other vehicles of a potential collision. The system will use the proximity sensors to determine if another vehicle 302 is moving toward the parked vehicle 301. As the moving vehicle 302 comes closer to the parked vehicle 301, the sensors will detect the proximity. At various proximity thresholds, the controller will illuminate lights on the light system 201. In one embodiment, the controller will sequentially illuminate the lights of the light system 201 to display how close the moving vehicle 302 is to the parked vehicle 301.

In a further embodiment the system is integrated into an autonomous or semi-autonomous vehicle. In this embodiment when the at least one sensor 103 or at least one camera 501 detects a close proximity the parked vehicle 301 is started by the system. In this embodiment the parked vehicle 301 will be relocated forward or backward to allow for the parked vehicle not to be bumped. As an added benefit this feature may help the moving vehicle 302 that is attempting to park fit into a spot. In this embodiment the controller is electrically coupled to the existing controller or controllers of the parked vehicle 301. The controller will then signal the parked vehicle 301 that the vehicles systems need to move the vehicle for safety and parking space optimization.

In one embodiment the system is connected to a plurality of autonomous or semi-autonomous vehicles. The systems on each vehicle are connected to a single system. In one embodiment this connection is a cloud base connection done using wireless transceivers. The system will allow for each of the vehicles with the system to calculate optimum distances to one another. The system will then move each of the vehicles in accordance with the respected capabilities such that each vehicle is an optimum distance from the others. This will allow for more efficient parking and less damage to vehicles in a confined space. In another embodiment, this system will help create more street parking by shortening the space in which cars need to park allowing for more vehicles overall to be parked on the street.

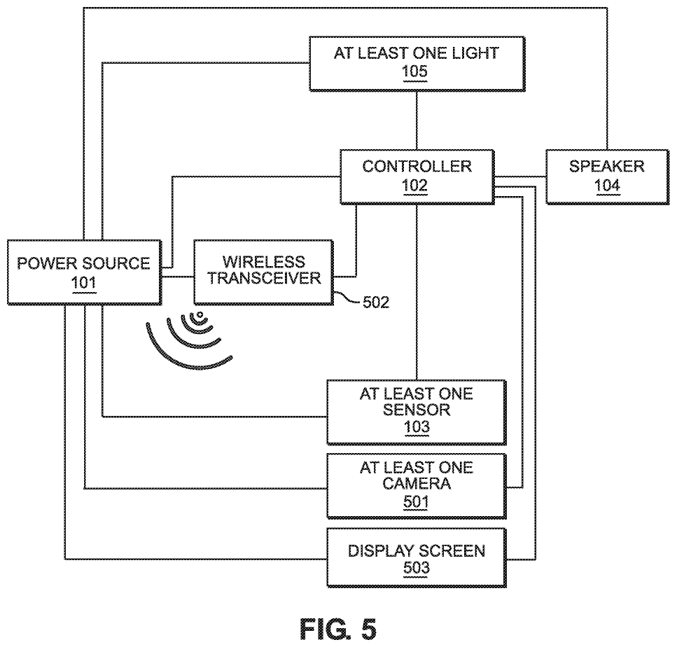

Referring now to FIG. 5, there is shown a wiring diagram of an embodiment of the parked vehicle active collision avoidance and multimedia system. In another embodiment of the system, there is a power source 101, a controller 102, at least one sensor 103, and a speaker 104. These components are connected as described in FIG. 1. In the shown embodiment, there is further at least one light 105 as described in FIG. 1. In other embodiments, the at least one light 105 is exchanged for the light system as described in FIG. 2.

In this embodiment, there is at least one camera 501 electrically coupled to the power source 101 and the controller 102. In one embodiment, the at least one camera 501 is configured to record images from the vehicle surroundings. In another embodiment, the at least one camera 501 is configured to record video of the vehicle surroundings. In one embodiment, the controller will tell the at least one camera 501 to activate similarly to the activations of the lights as described in FIG. 4.

In the shown embodiment, there is further a wireless transceiver 502. The wireless transceiver 502 is coupled to the power source 101 and the controller 102. In one embodiment, the wireless transceiver 502 will send messages to a vehicle owner. In another embodiment, the wireless transceiver 502 will receive media from external sources. This will allow the system to display advertisements and information as described below.

In one embodiment of the parked vehicle collision avoidance system, a display screen 503 is included. The display screen 503 is connected to the power source 101 and the controller 102. Using the wireless transceiver 502, the controller 102 can have the display screen 503 display various items. In further embodiments, the controller 102 will send corresponding outputs to both the display screen 503 and the speaker 104. In one embodiment, the display screen 503 will display local information such as weather. In another embodiment, the display screen 503 will display advertisements. The advertisements can be location specific. In one embodiment, the advertisements will be a result of the vehicle owner selling the display screen 503 as a means to advertise.

In one embodiment the wireless transceiver 502 connects to a mobile device of the vehicle owner. In one embodiment the system will send warning alerts to the car owner via the wireless transceiver. In one embodiment the vehicle owner can activate and control the vehicle from the mobile device. This will allow the vehicle owner to quickly move their vehicle protecting the vehicle.

In one embodiment the Parked Vehicle Active Collision Avoidance and Multimedia System will record street data. In one embodiment the system will record traffic volume. In another embodiment the system will record streets and parking lots. In one version of this embodiment the system can preform a mapping function. This mapping function can create new maps. In another embedment the mapping function will update existing maps. In one embodiment the collected data may be shared with different agencies to help better the roadways.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A parked vehicle active collision avoidance and multimedia system, the system comprising:
at least one proximity sensor secured to an exterior of a vehicle;
the at least one proximity sensor is electrically connected to a controller;
the controller is electrically connected to at least one light;
the controller illuminates the light when an object is detected within a threshold distance.

2) The parked vehicle active collision avoidance and multimedia system of claim 1, further comprising a power source electrically connected to the at least one proximity sensor, the controller, and the at least one light.

3) The parked vehicle active collision avoidance and multimedia system of claim 2, wherein the power source is a power source that is separate from the vehicle power source.

4) The parked vehicle active collision avoidance and multimedia system of claim 1, wherein the light is an LED light.

5) The parked vehicle active collision avoidance and multimedia system of claim 1, further comprising at least one speaker electrically connected to the controller.

6) The parked vehicle active collision avoidance and multimedia system of claim 5, wherein the controller will cause the speaker to play a sound when an object is detected within the threshold distance.

7) The parked vehicle active collision avoidance and multimedia system of claim 1, further comprising at least one camera secured to the exterior of the vehicle.

8) The parked vehicle active collision avoidance and multimedia system of claim 5, wherein the controller will cause the speaker to play a media message.

9) A parked vehicle active collision avoidance and multimedia system, the system comprising:
at least one proximity sensor secured to the exterior of a vehicle;
the at least one proximity sensor is electrically connected to a controller;
the controller is electrically connected to at least one light system, wherein the light system is comprised of multiple lights;
the controller illuminates at least one light of the light system when an object is detected within a threshold distance;
a power source is electrically connected to each part of the system;
a wireless transceiver electrically connected to the controller.

10) The parked vehicle active collision avoidance and multimedia system of claim 9, wherein the controller will illuminate additional lights of the light system as decreasing distance thresholds are passed.

11) The parked vehicle active collision avoidance and multimedia system of claim 9, further comprising a power source electrically connected to the at least one proximity sensor, the controller, and the at least one light.

12) The parked vehicle active collision avoidance and multimedia system of claim 9, wherein the power source is a power source that is separate from the vehicle power source.

13) The parked vehicle active collision avoidance and multimedia system of claim 9, wherein the light is an LED light.

14) The parked vehicle active collision avoidance and multimedia system of claim 9, further comprising at least one speaker electrically connected to the controller.

15) The parked vehicle active collision avoidance and multimedia system of claim 14, wherein the controller will cause the speaker to play a sound when an object is detected within the threshold distance.

16) The parked vehicle active collision avoidance and multimedia system of claim 9, further comprising at least one camera secured to the exterior of the vehicle.

17) The parked vehicle active collision avoidance and multimedia system of claim 14, wherein the controller will cause the speaker to play a media message.

18) The parked vehicle active collision avoidance and multimedia system of claim 9, further comprising a display screen.

19) The parked vehicle active collision avoidance and multimedia system of claim 18, wherein the display screen will display messages.

20) The parked vehicle active collision avoidance and multimedia system, wherein the wireless transceiver is in communication with a cloud based system.
